(19) United States
(12) Patent Application Publication
(10) Pub. No.: US 2024/0021182 A1
(43) Pub. Date: Jan. 18, 2024

(54) PEDAL UNIT AND ELECTRONIC KEYBOARD APPARATUS

(71) Applicant: YAMAHA CORPORATION, Hamamatsu-shi (JP)

(72) Inventors: Shin YAMAMOTO, Hamamatsu-shi (JP); Kenichi NISHIDA, Hamamatsu-shi (JP); Ryosuke NAKAMURA, Hamamatsu-shi (JP); Takahiro MIZUGUCHI, Hamamatsu-shi (JP); Masaaki MITA, Hamamatsu-shi (JP)

(21) Appl. No.: 18/364,774

(22) Filed: Aug. 3, 2023

Related U.S. Application Data
(63) Continuation of application No. PCT/JP2022/013205, filed on Mar. 22, 2022.

(30) Foreign Application Priority Data
Mar. 24, 2021 (JP) 2021-050481

(51) Int. Cl. G10H 1/34; G10H 1/00

(52) U.S. Cl. CPC G10H 1/348; G10H 1/0008; G10H 2220/221; G10H 2220/265

(57) ABSTRACT

A pedal unit 10 in one embodiment includes a case 190, a foot lever 100, and an elastic member 155. The foot lever 100 includes a first portion 100r located inside the case 190 and a second portion 100f located outside the case 190. The foot lever 100 is rotatably arranged with respect to the case 190. A center of rotation is located between the first portion 100r and the second portion 100f. The elastic member 155 is arranged within the case 190 and provides a force against the first portion 100r.

### CROSS-REFERENCE TO RELATED APPLICATIONS

This application is a Continuation of International Patent Application No. PCT/JP2022/013205, filed on Mar. 22, 2022, which claims the benefit of priority to Japanese Patent Application No. 2021-050481, filed on Mar. 24, 2021, the entire contents of which are incorporated herein by reference.

### FIELD

The present disclosure relates to a pedal unit.

### BACKGROUND

A pedal unit used in an electronic musical instrument detects a state in which a pedal is pressed (an end position) and a state in which a pedal is not pressed (a rest position), and transmits a detection result to a sound source device, thereby controlling a sound signal generated in the sound source device. Various techniques have been applied to such a pedal unit in order to obtain an operation feeling of a pedal of an acoustic piano. For example, Japanese Laid-Open Patent Publication No. 2009-258642 discloses a technique for providing hysteresis for a reaction force against the pressing of a pedal.

### SUMMARY

A pedal of an upright piano and a pedal of a grand piano are different from each other in function and structure. For example, a distance between a center of rotation of the pedal and a front end of the pedal is different between the grand piano and the upright piano. This distance is smaller for the grand piano than for the upright piano. As a result, the grand piano and the upright piano have different aspects of rotation when the pedal is pressed. On the other hand, conventional pedal units used in an electronic musical instrument all have a center of rotation set at a position corresponding to the pedal of the upright piano. Therefore, it is desired to develop a pedal unit capable of obtaining an operation feeling corresponding to the pedal of the grand piano.

One of the objects of the present disclosure is to bring an operation feeling of the pedal of the pedal unit closer to an operation feeling of the pedal of the grand piano.

In an embodiment, a pedal unit includes a case, a foot lever, and an elastic member. The foot lever includes a first portion located inside the case and a second portion located outside the case. The foot lever is rotatably arranged with respect to the case. A center of rotation is located between the first portion and the second portion. The elastic member is arranged within the case and applies a force against the first portion.

The elastic member may be arranged on the first portion.

The elastic member may be a spring formed of a metal.

The pedal unit may further include a sensor arranged at a higher position than the first portion and may detect a position of the foot lever as the foot lever rotates.

An upper surface of the second portion may include a horizontal surface at a predetermined position in a range of rotation of the foot lever.

An upper surface of the first portion may have an area arranged at a position lower than the upper surface of the second portion.

An upper apex portion of the second portion in the foot lever may be higher than the center of rotation in a rest position and lower than the center of rotation in an end position.

The center of rotation may be arranged lower than the second portion.

The case may include a structure supporting any one of a shaft and a bearing forming the center of rotation from below the foot lever.

A width of part of the foot lever arranged above the center of rotation may be wider than a width of an area where a shaft and a bearing forming the center of rotation face each other.

An edge in a cross-section of a shaft forming the center of rotation may have an arc shape.

The pedal unit may further include a shaft fixed to the foot lever and forming the center of rotation and a bearing fixed to the case and forming the center of rotation.

The center of rotation may be located inside the case, and at least a part of an area where a shaft and a bearing forming the center of rotation face each other may overlap the second portion in the case where the foot lever is viewed from above.

The pedal unit may further include a stopper for supporting the first portion of the foot lever from below in a rest position, wherein the elastic member may apply a force to the first portion between the center of rotation and the stopper.

The pedal unit may further include a lower stopper and an upper stopper defining a range of rotation of the foot lever in the first portion and a guide member regulating a direction of rotation of the foot lever inside the case, wherein part of the upper stopper may be arranged above the guide member, and part of the lower stopper may be arranged below the guide member.

The guide member may be in contact with at least one of the upper stopper and the lower stopper.

The pedal unit may further include a guide member regulating a direction of rotation of the foot lever in the first portion, and a contact member arranged on the first portion of the foot lever and moving in contact with the guide member as the foot lever rotates, the contact member having an integral structure with any one of a shaft and a bearing forming the center of rotation of the foot lever.

The pedal unit may further include a guide member regulating a direction of rotation of the foot lever in the first portion, and a contact member arranged on the first portion of the foot lever and moving in contact with the guide member as the foot lever is rotated, wherein the contact member may have an area for elastic deformation and is arranged in a state applying a restoring force in a direction from the foot lever to the guide member.

The guide member may have a first guide surface and a second guide surface, wherein the first guide surface may be arranged opposite to the second guide surface with respect to the foot lever, and the first guide surface and the second guide surface may be non-parallel.

The guide member may have a first guide surface and a second guide surface, wherein the first guide surface may be arranged opposite to the second guide surface with respect to the foot lever, and the first guide surface and the second guide surface may be parallel to each other.

Further, an electronic keyboard apparatus according to an embodiment includes the pedal unit described above, a keyboard unit having a plurality of keys, and a sound source unit that generates a sound signal according to an operation on the key and an operation on the foot lever in the pedal unit.

According to the present disclosure, it is possible to bring an operation feeling of a pedal of a pedal unit close to an operation feeling of a pedal of a grand piano.

### BRIEF DESCRIPTION OF DRAWINGS

FIG. 1 is a diagram showing an appearance of an electronic keyboard apparatus according to an embodiment.

FIG. 2 is a diagram showing a configuration of an electronic keyboard apparatus according to an embodiment.

FIG. 3 is a diagram showing a configuration of a pedal unit according to a first embodiment.

FIG. 4 is a diagram showing a positional relationship between a foot lever and a shaft.

FIG. 5 is a diagram showing a pedal unit when the foot lever is rotated to just before a half-pedal state.

FIG. 6 is a diagram showing a pedal unit when the foot lever is rotated to an end position.

FIG. 7 is a diagram showing a configuration of a pedal unit according to a second embodiment.

FIG. 8 is a diagram showing a configuration of a pedal unit according to a third embodiment.

FIG. 9 is a diagram showing a configuration of a pedal unit according to a fourth embodiment.

FIG. 10 is a diagram showing a configuration of a pedal unit according to a fifth embodiment.

FIG. 11 is a diagram showing a configuration of a cross-section (D1-D2) of a guide structure according to the fifth embodiment.

FIG. 12 is a diagram showing a configuration of a cross-section (D3-D4) of the guide structure according to the fifth embodiment.

FIG. 13 is a diagram showing a configuration of a pedal unit according to a sixth embodiment.

FIG. 14 is a diagram showing a configuration of a cross-section of a guide member according to the sixth embodiment.

FIG. 15 is a diagram showing a configuration of a cross-section (E1-E2) of a shaft according to the sixth embodiment.

### DESCRIPTION OF EMBODIMENTS

Hereinafter, an embodiment of the present disclosure will be described in detail with reference to the drawings. The following embodiments are examples, and the present disclosure should not be construed as being limited to these embodiments. In the drawings referred to in the present embodiment, the same or similar parts are denoted by the same symbols or similar symbols (symbols only denoted by A, B, or the like after the numerals), and repetitive description thereof may be omitted. In the drawings, dimensional ratios may be different from actual ratios, or part of a configuration may be omitted from the drawings for clarity of explanation.

### First Embodiment

### [1. Electronic Keyboard Apparatus]

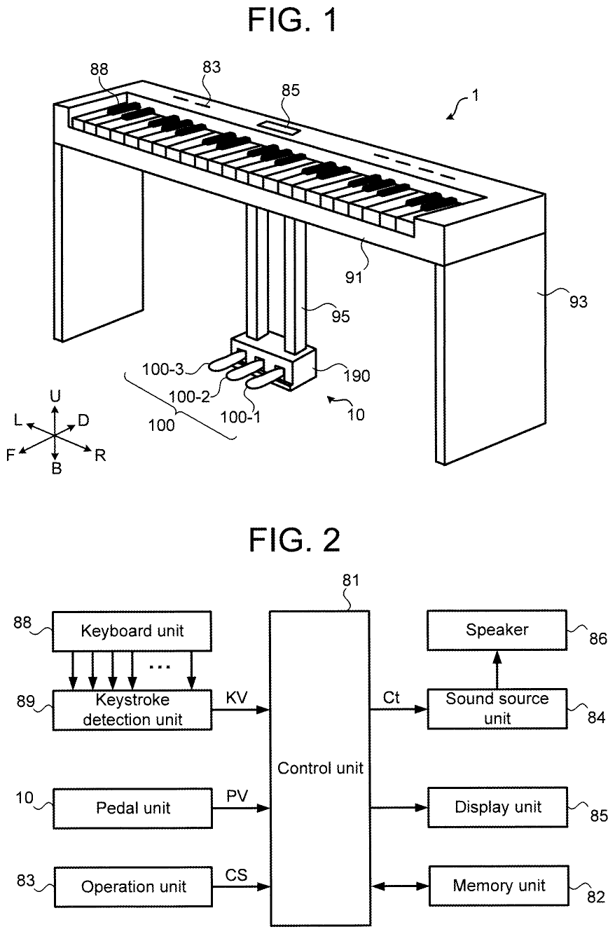

FIG. 1 is a diagram showing an appearance of an electronic keyboard apparatus according to an embodiment. An electronic keyboard apparatus 1 includes a pedal unit 10, a keyboard body 91, a support plate 93 supporting the keyboard body 91 at a predetermined height, and a support column 95 suspending and supporting the pedal unit 10 from the keyboard body 91. The pedal unit 10 may be separable from the keyboard body 91. In this case, the pedal unit 10 and the support column 95 may be separated from each other, or the support column 95 and the keyboard body 91 may be separated from each other.

The keyboard body 91 includes an operation unit 83, a display unit 85, and a keyboard unit 88 composed of a plurality of keys. The pedal unit 10 includes a case 190 and at least one foot lever 100 protruding from the case 190. In this example, the pedal unit 10 includes three foot levers 100-1, 100-2, and 100-3. In terms of function, the foot lever 100-1 corresponds to a damper pedal, the foot lever 100-2 corresponds to a sostenuto pedal, and the foot lever 100-3 corresponds to a shift pedal. In the following description, the three foot levers 100-1, 100-2, and 100-3 are shown as the foot lever 100 unless they are separately described. The foot lever 100 may also be referred to as a pedal arm.

As shown in FIG. 1, a front direction F, a depth direction D, an upper direction U, a bottom direction B, a left direction L, and a right direction R are defined with reference to a user (a player) who plays the electronic keyboard apparatus 1. In other words, the front direction F and the depth direction D are along a longitudinal direction of the key. The longitudinal direction of the key may be referred to as a front-rear direction. The left direction L and the right direction R are along an array direction of the keys. The key array direction may be referred to as a left-right direction. The right direction R corresponds to a treble side of the key. A plane including the front-rear direction and the left-right direction may be referred to as a horizontal plane. The upper direction U and the bottom direction B are along a vertical direction. The vertical direction may be referred to as an up-down direction. The horizontal plane is used as a reference for the height. For example, the case where a first configuration is higher than a second configuration includes not only the case where the first configuration is present in an area in the upper direction U of the second configuration (an area directly above the second configuration), but also the case where the first configuration is present in an area shifted from the area in the left-right direction or the front-rear direction. The same definitions are applied to the description of the following drawings.

According to the pedal unit 10 of the embodiment, adopting a structure different from the conventional structure for its internal structure makes it possible to bring an operation feeling of the pedal closer to an operation feeling of a pedal of a grand piano. Hereinafter, each configuration of the electronic keyboard apparatus 1 will be described, and in particular, the pedal unit 10 will be described in detail.

FIG. 2 is a block diagram showing a configuration of an electronic keyboard apparatus according to an embodiment. The electronic keyboard apparatus 1 includes the pedal unit 10, a control unit 81, a memory unit 82, the operation unit 83, a sound source unit 84, the display unit 85, a speaker 86, the keyboard unit 88, and a key press detection unit 89.

The key press detection unit 89 detects a pressing operation on a key included in the keyboard unit 88, and outputs a key signal KV corresponding to a detection result to the control unit 81. The key signal KV includes information corresponding to a key to be operated and an operation amount of the key. The pedal unit 10 detects the pressing operation on the foot lever 100 and outputs a pedal signal PV corresponding to a detection result to the control unit 81. The pedal signal PV includes information corresponding to a pedal to be operated and an operation amount of the pedal.

The operation unit 83 includes operation devices such as a knob, a slider, a touch sensor, and a button, and receives an instruction from the user to the electronic keyboard apparatus 1. The operation unit 83 outputs an operation signal CS corresponding to the received user's instruction to the control unit 81.

The memory unit 82 is a memory device such as a nonvolatile memory, and includes an area for storing a control program executed by the control unit 81. The control program may be provided from an external device. Various functions are realized in the electronic keyboard apparatus 1 when the control program is executed by the control unit 81.

The control unit 81 is an example of computer including a calculation processing circuit such as a CPU and a memory device such as a RAM and a ROM. The control unit 81 executes the control program stored in the memory unit 82 by the CPU, and implements various functions in the electronic keyboard apparatus 1 according to instructions described in the control program. For example, the control unit 81 generates a sound source control signal Ct based on the key signal KV, the pedal signal PV, and the operation signal CS.

The sound source unit 84 includes a DSP (Digital Signal Processor). The sound source unit 84 generates a sound signal based on the sound source control signal Ct supplied from the control unit 81. In other words, the sound source unit 84 generates a sound signal according to an operation on the key of the keyboard unit 88 and an operation on the foot lever 100 of the pedal unit 10. The sound source unit 84 may supply the generated sound signal to the speaker 86. The speaker 86 generates a sound corresponding to the sound signal by amplifying and outputting the sound signal supplied from the sound source unit 84. The display unit 85 includes a display device such as a liquid crystal display, and displays various screens under the control of the control unit 81. A touch panel may be configured by combining a touch sensor with the display unit 85.

### [2. Configuration of Pedal Unit]

Next, a configuration of the pedal unit 10 will be described. In the following description, a description will be given focusing on one foot lever 100.

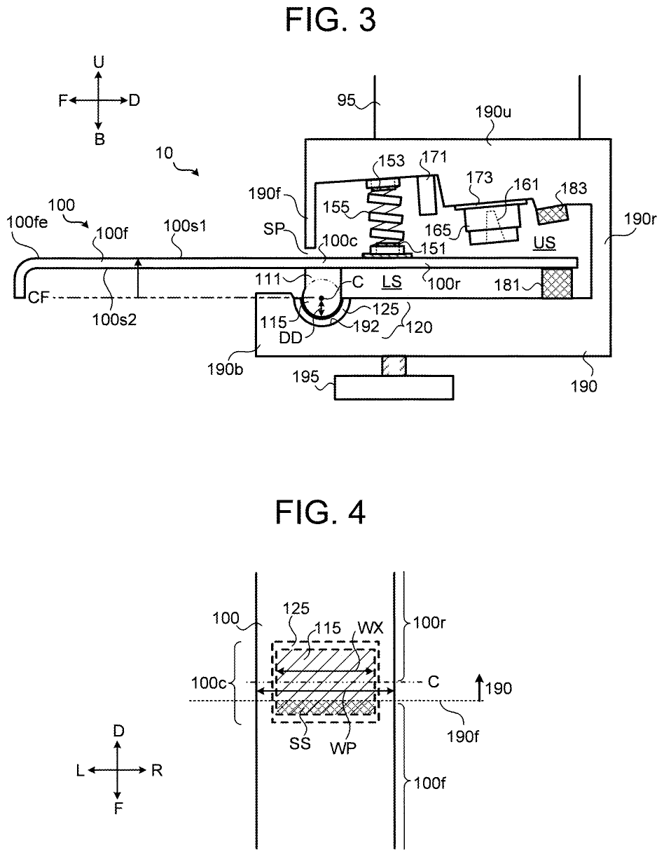

FIG. 3 is a diagram showing the configuration of the pedal unit according to a first embodiment. FIG. 3 shows a state in which the foot lever 100 is not pressed, that is, a state in which the foot lever 100 is present in a rest position. The pedal unit 10 includes the case 190 that houses the foot lever 100 and part of the foot lever 100. In this example, the pedal unit 10 includes an auxiliary tool 195 for assisting in fixing a position of the case 190 with respect to the floor on a bottom surface of a bottom portion 190b.

For example, the case 190 is formed of an FRP (fiber-reinforced resin), but may be formed of other resins such as a PBT resin, an ABS resin, a POM resin, a PPS resin, a PEEK resin, and may be formed of a metal. The case 190 includes the bottom portion 190b, a ceiling portion 190u, and side portions. The side portions are wall portions connecting the bottom portion 190b and the ceiling portion 190u. The ceiling portion 190u and the bottom portion 190b are configured to be separable from each other, and are fixed to each other by screws or the like via the side portions. In this example, although the side portion and the ceiling portion 190u are integrally formed, the side portion and the bottom portion 190b may be integrally formed. In FIG. 3, a front portion 190f and a rear portion 190r of the side portions are shown. The portions of the side portions arranged in the left direction L and the right direction R are not shown. There is an opening between the front portion 190f and the bottom portion 190b. The foot lever 100 is arranged such that part of the foot lever 100 is inside the case 190 and the remaining portion is outside the case 190. The foot lever 100 is rotatably arranged with respect to the case 190 by a shaft 115 and a bearing 120, which will be described below. A center of rotation C is located inside the case 190. The opening has a size that does not interfere with a range of rotation of the foot lever 100.

The foot lever 100 is formed of a metal and its long side is in the front-rear direction. In following description, in the foot lever 100, an area in the depth direction D with respect to the center of rotation C is referred to as a first area 100r (a first portion), and an area in the front direction F with respect to the center of rotation C and outside the case 190 are referred to as a second area 100f (a second portion). A surface of the foot lever 100 in the upper direction U is referred to as an upper surface 100s1, and a surface in the bottom direction B is referred to as a bottom surface 100s2. It is assumed that the upper surface 100s1 and the bottom surface 100s2 do not include a portion bent bottom direction B at the tip portion of the foot lever 100 in the second area 100f.

In this example, the upper surface 100s1 includes a horizontal plane when the foot lever 100 is in the rest position. Since the second area 100f is tilted so as to be relatively higher or lower with respect to the first area 100r, the upper surface 100s1 may not include a horizontal plane. For example, the upper surface 100s1 may include a substantially horizontal plane. In this example, the substantially horizontal plane is a concept that includes up to a 5-degree tilt with respect to the horizontal plane. In the case where the foot lever 100 is in the rest position and does not include the horizontal surface, a state in which the upper surface 100s1 includes the horizontal surface in the range of rotation may be realized, or a state in which the upper surface 100s1 includes the horizontal surface in any position of the range of rotation may not be realized.

An area located substantially at a center of the foot lever 100 in the longitudinal direction (hereinafter, referred to as a central area 100c) is connected to a shaft support portion 111 on the bottom surface 100s2. The shaft 115 is connected to a tip of the shaft support portion 111. That is, the shaft support portion 111 connects the shaft 115 and the foot lever 100, and supports the shaft 115 with respect to the foot lever 100.

The shaft 115 forms a rotation axis extending along the left-right direction, and has an arc shape at an edge portion of a cross-section perpendicular to the rotation axis. The arc shape corresponds to part of a circle centered on the center of rotation C. The shaft 115 is formed of a resin different from the resin of the case 190. For example, the shaft 115 is formed of a POM resin, but may be formed of other resins such as PBT resin, ABS resin, nylon resin, PTFE resin, UHPE resin, PEEK resin, or the like. The bearing 120 paired with the shaft 115 includes a contact portion 125 and a bearing support portion 192. The contact portion 125 contacts a portion on which the shaft 115 is placed and corresponding to the arc shape in the shaft 115. A surface where the contact portion 125 contacts the shaft 115 is referred to as a contact surface. Therefore, the shaft 115 and the contact portion 125 slide when the foot lever 100 rotates. The bearing support portion 192 supports the contact portion 125 from the side opposite to the contact surface. In this example, although the bearing support portion 192 corresponds to part of the case 190, the bearing support portion 192 may be formed of a member different from the case 190. Therefore, the contact portion 125 is sandwiched between the shaft 115 and the bearing support portion 192. The bearing support portion 192 can also be referred to as a surface that supports the contact portion 125 (hereinafter, sometimes referred to as a support surface). In this case, the contact surface and the support surface face each other at least partially.

In this example, the contact surface and the support surface differ only in distances from the center of rotation C and have a similarity but may not have such a relationship. The contact surface has a shape in which the distance from the center of rotation C is equal at any position. This distance may be referred to as a radius of curvature DD in the following explanation, and corresponds to the radius of the shaft 115. The radius of curvature DD may be appropriately set to, for example, preferably 3.5 mm or more, and more preferably 4.0 mm or more. On the other hand, the support surface may have a shape in which the distance from the center of rotation C is different depending on the position, and may be a shape in which the contact portion 125 is supported by the bearing support portion 192. Although a positional relationship between the bearing support portion 192 and the contact portion 125 is fixed, it is sufficient that the positional relationship is fixed in at least a direction where the bearing support portion 192 and the contact portion 125 slide against each other. That is, it is sufficient that the contact portion 125 is fixed so as not to rotate with respect to the bearing support portion 192 when the shaft 115 rotates with respect to the bearing 120.

The contact portion 125 is formed of a resin different from the resins of the shaft 115 and the bearing support portion 192 (the case 190). For example, the contact portion 125 is formed of PBT resin, but may be formed of other resins such as POM resin, ABS resin, nylon resin, PTFE resin, UHPE resin, PEEK resin, or the like. A relationship between the resin material of the contact portion 125 and the resin material of the shaft 115 is determined so that a desired frictional force is obtained between the contact portion 125 and the shaft 115 and wear is reduced.

FIG. 4 is a diagram showing a positional relationship between a foot lever and a shaft. FIG. 4 corresponds to a situation in which the foot lever 100 is viewed in a direction (in this case, the bottom direction B) perpendicular to the center of rotation C (rotation axis). According to this drawing, a width WP of part of the foot lever 100 located above the rotation axis is wider than a width WX of an area (contact surface) where the shaft 115 and the contact portion 125 face each other and contact with each other. These widths are lengths in the left-right direction (lengths along the rotation axis). The shaft 115 is arranged inside the foot lever 100 as described above, so that the shaft 115 cannot be seen when the foot lever 100 is viewed from the upper surface 100s1. In this example, the center of rotation C is located inside the case 190.

In this example, as shown in FIG. 4, at least part of the contact surface overlaps the second area 100f (area shown by mesh). Such an overlapping area may not be present. The center of rotation C may be present outside the case 190 but is preferably present inside the case 190.

Returning to FIG. 3, the description will be continued. An elastic member 155, a reaction force adding member 165, a stroke sensor 171, a contact sensor 173, a lower stopper 181, and an upper stopper 183 are arranged in the inner space of the case 190.

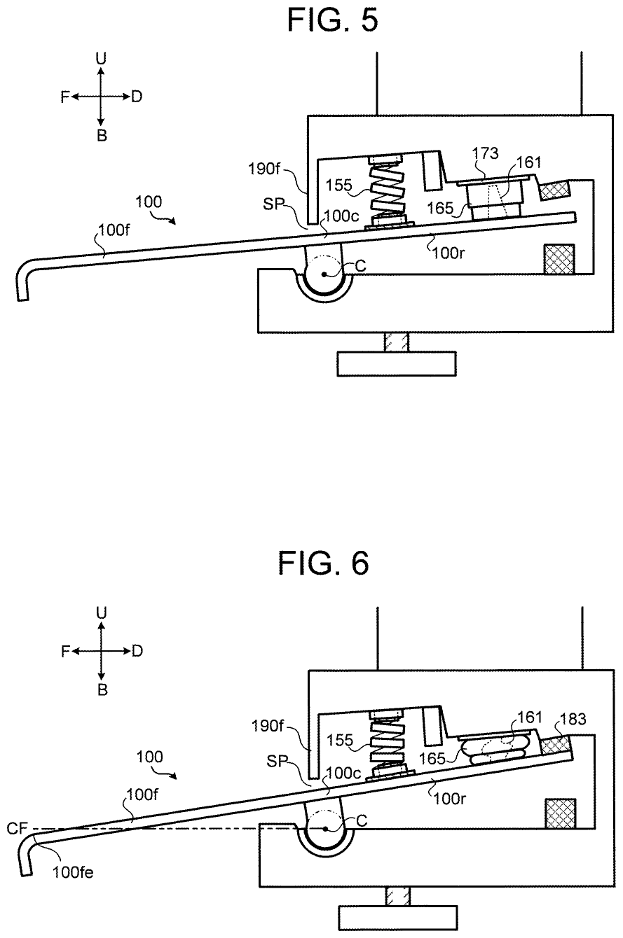

In this example, the elastic member 155 is a spring formed of metal, but may not be formed of metal, and may not be spring-shaped. That is, the elastic member 155 may be any member that generates an elastic force by elastic deformation. The elastic member 155 is arranged in an upper space US formed at a position higher than the first area 100r in the inner space of the case 190. An upper end portion of the elastic member 155 is supported by a support member 153 fixed to the ceiling portion 190u. A lower end portion of the elastic member 155 is supported by a support member 151 fixed to the upper surface 100s1 in the first area 100r. The axial direction of the spring forming the elastic member 155 preferably coincides with the direction of rotation (circumferential direction) of the part in contact with the first area 100r at any position (for example, the end position, the rest position, or a position where the reaction force adding member 165 contacts the foot lever 100 (refer to FIG. 5)) in the rotational range of the foot lever 100.

The elastic member 155 is supported by the support members 151 and 153 in a state of being compressed more than its natural length and applies a force to the first area 100r to hold the foot lever 100 in the rest position. The force applied to the first area 100r includes a component in the bottom direction B. The elastic member 155 presses the first area 100r against the lower stopper 181 and presses the shaft 115 against the contact portion 125 by the elastic force. The second area 100f operated by the user is an area relatively close to the center of rotation C. Even if the elastic force of the elastic member 155 is reduced, a large reaction force can be applied to the second area 100f due to a relationship of a lever ratio. Therefore, the strength of the case 190 required to support the elastic member 155 may be small, and the degree of freedom in the material and a shape of the case 190 is improved.

The lower stopper 181 is arranged on the bottom portion 190b and contacts the bottom surface 100s2 of the first area 100r in the foot lever 100. The lower stopper 181 contacts part of the first area 100r that is located in the depth direction D with respect to the elastic member 155 (in this example, an end of the foot lever 100 in the first area 100r side). In other words, the portion of the foot lever 100 to which the force is applied by the elastic member 155 is present between the shaft 115 and the lower stopper 181. In this state, the rest position of foot lever 100 is defined. The more the position of the lower stopper 181 is away from the center of rotation C, the higher the positioning accuracy can be. The foot lever 100 is stably supported in the pedal unit 10 by applying force to the first area 100r by the elastic member 155 by such a positional relationship.

The upper stopper 183 is arranged on the ceiling portion 190u and contacts the upper surface 100s1 of the first area 100r in the foot lever 100. In this example, the upper stopper 183 contacts the end portion of the first area 100r in the foot lever 100. In this state, the end position of the foot lever 100 is defined (corresponding to FIG. 6). The more the position of the upper stopper 183 is away from the center of rotation C, the higher the positioning accuracy can be. In this way, the foot lever 100 can rotate between the rest position and the end position (that is, the range of rotation).

The stroke sensor 171 is arranged on the ceiling portion 190u and is a sensor for detecting the behavior (for example, amount of rotation) of the foot lever 100. In this example, the stroke sensor 171 includes an optical sensor for measuring a position of the first area 100r (a displacement from the reference position). The optical sensor in the stroke sensor 171 is a passive element that changes an electric signal by changing a position of a detection target. In this example, the optical sensor serving as the passive element is arranged in the upper direction U of the first area 100r, but may be arranged to be shifted in the left-right direction with respect to the first area 100r. That is, the optical sensor may be arranged at a position higher than the first area 100r instead of being arranged directly above the first area 100r. In other words, the optical sensor may be arranged in the upper space US. The stroke sensor 171 may be a sensor that detects the position of the first area 100r corresponding to the rest position and the end position in the range of rotation, or may be a sensor that detects the position of the first area 100r in a predetermined range in the vicinity of the position where the first area 100r contacts the reaction force adding member 165. The amount of rotation of the foot lever 100 (the amount of pressing of the foot lever 100) can be calculated based on the detection result of the stroke sensor 171. Information corresponding to the calculated amount of rotation is included in the above-described pedal signal PV.

The contact sensor 173 is arranged on the ceiling portion 190u and detects the contact with a predetermined detecting position. In this example, the reaction force adding member 165 is a dome-shaped member formed of an elastic member such as rubber and forms a space therein. The reaction force adding member 165 includes a protruding portion 161 protruding toward the inner space. The reaction force adding member 165 is arranged so as to cover the detecting position by the contact sensor 173 in the upper space US from below. The reaction force adding member 165 deforms when a force is applied from below. The contact sensor 173 outputs a predetermined detection signal when the protruding portion 161 contacts the detection position by the contact sensor 173 due to the deformation. The detection signal is also included in the pedal signal PV. The reaction force adding member 165 may have the same spring shape as the elastic member 155 and may be configured to be elastically deformed. The detection by the contact sensor 173 may be performed in a process of the elastic deformation of the reaction force adding member 165.

### [3. Operation of Pedal Unit]

Next, an operation of rotating the foot lever 100 from the rest position to the end position will be described. When the foot lever 100 is pressed and rotated, the second area 100f, which is a portion to be pressed, is lowered, and the first area 100r is raised. In this case, the elastic member 155 is gradually compressed to increase the elastic force, thereby increasing the force (reaction force) required to lower the second area 100f. In this case, a frictional force is generated by sliding of the shaft 115 and the contact portion 125. The frictional force and the elastic force are perceived by the user as a reaction force when the foot lever 100 is pressed.

As the force used by the user presses the foot lever 100 is increased so as to resist an increase in the reaction force, the elastic member 155 becomes a fulcrum, and thus the force (normal force) applied from the shaft 115 to the contact portion 125 is increased. As a result, the frictional force generated between the shaft 115 and the contact portion 125 also increases, and the reaction force further increases.

FIG. 5 is a diagram showing the pedal unit when the foot lever is rotated until just before a half-pedal state. As shown in FIG. 5, when the foot lever 100 is further pressed and rotated, the first area 100r contacts the reaction force adding member 165 in a state where the foot lever is being moved from the rest position toward the end position. In this case, the upper surface 100s1 of the first area 100r and the reaction force adding member 165 are preferably in surface contact.

When the second area 100f is further lowered from this state, the reaction force adding member 165 begins to deform due to the first area 100r. This increases a degree of increase of the reaction force due to the elastic force of the reaction force adding member 165 in addition to the elastic force of the elastic member 155. The user perceives the change in the reaction force and further presses the foot lever 100 so that the user can perceive that the foot lever has approached the half-pedal state. When the second area 100f is further lowered, the contact sensor 173 detects that the protruding portion 161 is in contact with the detection position. For example, a pedal signal PV including a detection signal obtained in response to the detection is transmitted to the control unit 81, and the sound source unit 84 can be controlled so as to give a half-pedal effect to the sound signal.

FIG. 6 is a diagram showing the pedal unit when the foot lever is rotated to the end position. When the second area 100f is further lowered from the half-pedal state, the deformation of the reaction force adding member 165 is further increased, and the protruding portion 161 also starts to deform. As shown in FIG. 6, the foot lever 100 reaches the end position by contacting the first area 100r with the upper stopper 183.

As shown in FIG. 3, FIG. 5, and FIG. 6, since the central area 100c of the foot lever 100 is in the vicinity of the center of rotation C, a size of a separation part SP between the central area 100c and the front portion 190f does not significantly change even when the foot lever 100 rotates. Therefore, the separation part SP can be made small, pinching of the finger or the like can be prevented, and the inner structure of the case 190 can be made difficult to see from the outside. It is more effective to make the thickness of the front portion 190f (the length in the front-rear direction) thinner than the distance from the center of rotation C to the contact surface (radius of curvature DD).

As shown in FIG. 3, at the rest position, the upper surface 100s1 of the foot lever 100 (at least an upper apex portion 100fe of the front direction F in the upper surface 100s1) is located at a position higher than the horizontal plane including the center of rotation C (hereinafter, referred to as the axis horizontal plane CF). On the other hand, as shown in FIG. 6, at least part of the upper surface 100s1 in the foot lever 100 is located at a position lower than the axis horizontal plane CF at the end position. In this example, the upper apex portion 100fe of the upper surface 100s1 in the second area 100f is located at a position lower than the axis horizontal plane CF.

The foot lever 100 according to an embodiment has a shorter distance from the center of rotation C to the upper apex portion 100fe. The shorter the distance, the greater the amount of movement in the upper apex portion 100fe in the front-rear direction when the foot lever 100 is pressed. Setting a positional relationship between the upper apex portion 100fe and the axis horizontal plane CF as described above makes it possible to reduce the amount of movement of the upper apex portion 100fe in the front-rear direction due to the rotation of the foot lever 100. The positional relationship between the upper apex portion 100fe and the axis horizontal plane CF is not limited to this example. For example, the upper apex portion 100fe may be located at a position lower than the axis horizontal plane CF in the rest position, or may be located at a position higher than the axis horizontal plane CF in the end position.

In the pedal unit 10 used in the electronic keyboard apparatus 1, the first area 100r and the second area 100f are arranged with the center of rotation C interposed therebetween, and the rotation of the foot lever 100 is realized by a seesaw type rotation. As a result, it is possible to make the upper space US above the upper surface 100s1 side in the first area 100r bigger and to make a lower space LS above the bottom surface 100s2 side in the first area 100r smaller. The pedal unit 10 is arranged in a portion close to an installation surface of the electronic keyboard apparatus 1. Therefore, the flexibility of design is improved by making the area (lower space LS) lower than the foot lever 100 as small as possible.

### Second Embodiment

In the first embodiment, the shaft 115 is fixed to the foot lever 100, and the bearing 120 is fixed to the case 190. The relationship between the shaft and the bearing may be reversed. In a second embodiment, an example in which the relationship between the shaft and the bearing in the first embodiment is reversed will be described.

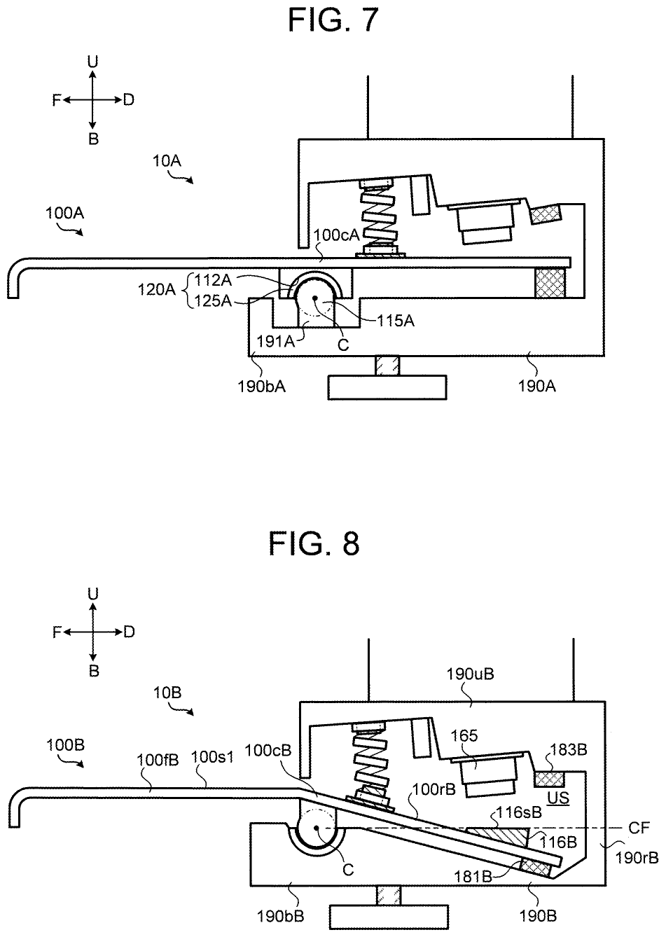

FIG. 7 is a diagram showing a configuration of a pedal unit according to the second embodiment. In a pedal unit 10A according to the second embodiment, a bearing 120A is fixed to a foot lever 100A, and a shaft 115A is fixed to a case 190A. The shaft 115A is supported by a shaft support portion 191A protruding upward with respect to a bottom portion 190bA. The bearing 120A includes a contact portion 125A and a bearing support portion 112A that supports the contact portion 125A from the opposing side of the contact surface. The bearing support portion 112A is connected to a central area 100cA. Part of the pedal unit 10A according to the second embodiment that is the same as the pedal unit 10 according to the first embodiment will not be described.

### Third Embodiment

The foot lever 100 in the first embodiment has a configuration that is not bent except for the front direction F from the upper apex portion 100fe. In a third embodiment, an example in which part of the foot lever is bent and the first area 100r and the second area 100f are inclined at a predetermined angle will be described.

FIG. 8 is a diagram showing a configuration of a pedal unit according to the third embodiment. A pedal unit 10B in the third embodiment is bent in a central area 100cB. In this example, a first area 100rB is bent in the bottom direction B with respect to a second area 100fB. In other words, the first area 100rB has an area arranged at a position lower than the upper surface 100s1 of the second area 100fB. The area in which the first area 100rB moves due to the rotation of the foot lever 100 is changed to the bottom direction B as compared with the case of the first embodiment.

Therefore, a bottom portion 190bB and a ceiling portion 190uB of a case 190B have a configuration in which a space moved in the bottom direction B is formed on a side of a rear portion 190rB as compared with the case of the first embodiment. A lower stopper 181B and an upper stopper 183B are arranged at positions corresponding to the range in which the first area 100rB moves. This makes it possible to secure a large upper space US. The pedal unit 10B may be downsized instead of enlarging the upper space US.

In this example, a correction member 116B is arranged on the upper surface 100s1 of the first area 100rB. In the rest position, an upper surface 116Bs of the correction member 116B forms the same plane as the axis horizontal plane CF described above. The upper surface 116Bs is a surface that contacts the reaction force adding member 165 when a foot lever 100B is rotated. In the case where the position of the upper surface 116Bs is set in this manner, the upper surface 116Bs can apply a force perpendicular to the reaction force adding member 165. The explanation regarding part of the pedal unit 10B according to the third embodiment which is the same as the pedal unit 10 according to the first embodiment is omitted here.

The foot lever 100B is not limited to having one bent portion but may have a plurality of bent portions. The bent portion may be a portion separate from the central area 100cB. Since the foot lever 100B is bent at a plurality of positions, the upper surface 100s1 of the second area 100fB may be arranged at a position lower than the axis horizontal plane CF.

### Fourth Embodiment

In the first embodiment, the elastic member 155 is arranged in the upper space US. The location where the elastic member 155 is arranged is not limited to the upper space US. In a fourth embodiment, an example in which the elastic member 155 is arranged in the lower space LS will be described.

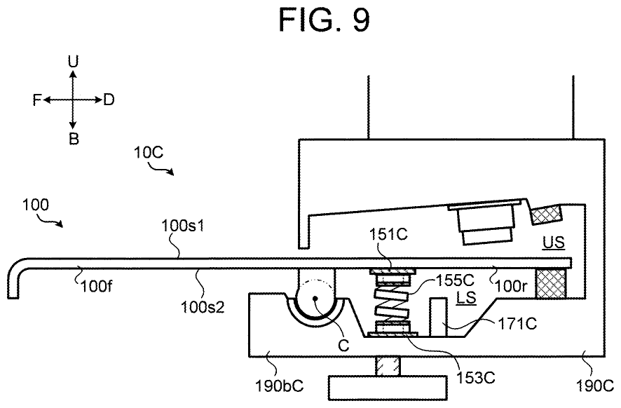

FIG. 9 is a diagram showing a configuration of a pedal unit according to the fourth embodiment. A pedal unit 10C according to the fourth embodiment includes an elastic member 155C arranged in the lower space LS. A support member 151C is connected to the bottom surface 100s2 of the first area 100r, supports the upper end of the elastic member 155C, and fixes the upper end of the elastic member 155C so as not to be disengaged in the bottom direction B. A support member 153C is connected to a bottom portion 190bC, supports the lower end of the elastic member 155C, and fixes the lower end of the elastic member 155C so as not to be disengaged in the upper direction U.

The elastic member 155C is supported by the support members 151C and 153C in a state extending beyond its natural length and applies a force to the first area 100r to hold the foot lever 100 in the rest position. The force applied to the first area 100r includes a component in the bottom direction B. That is, the direction of the force which the first area 100r receives is the same as that in the first embodiment.

In this example, a stroke sensor 171C is also arranged in the lower space LS and measures the displacement of the bottom surface 100s2 in the first area 100r. The stroke sensor 171C may be arranged in the upper space US. A case 190C has a configuration in which the elastic member 155C and the stroke sensor 171C can be arranged in the lower space LS. The explanation regarding part of the pedal unit 10C according to the fourth embodiment that is the same as the pedal unit 10 according to the first embodiment is omitted.

### Fifth Embodiment

In a fifth embodiment, a pedal unit 10D in which a guide structure for restricting the rotational direction of the foot lever 100 is arranged in the first area 100r of the foot lever 100 will be described.

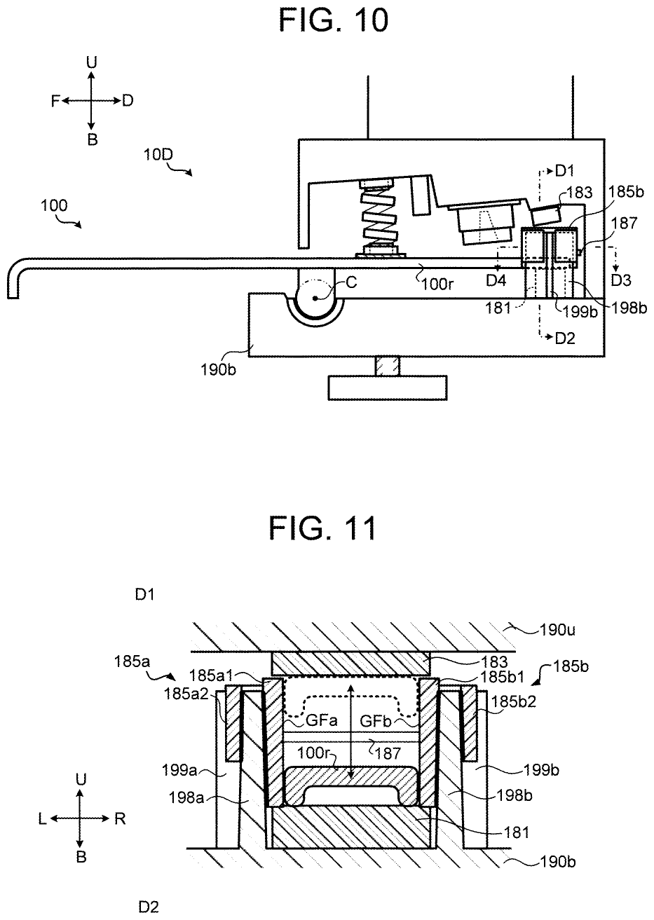

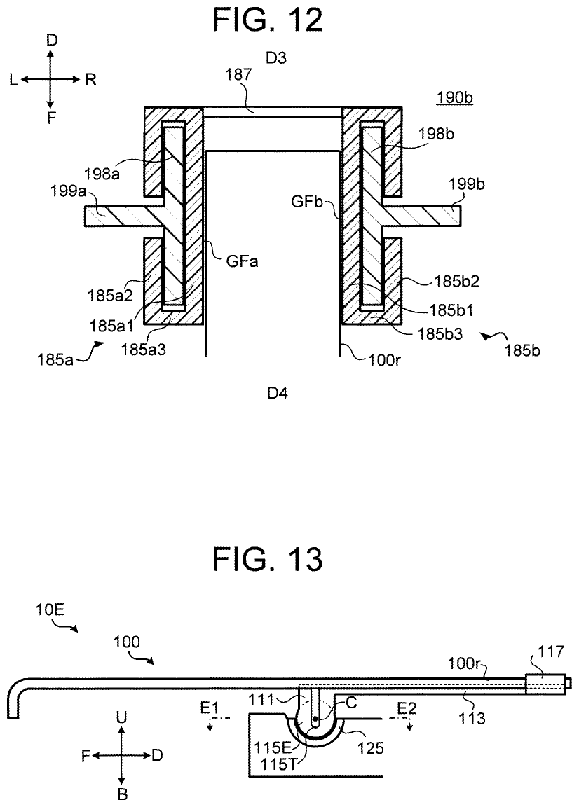

FIG. 10 is a diagram showing a configuration of a pedal unit according to the fifth embodiment. FIG. 11 is a diagram showing a configuration of a cross-section (D1-D2) of the guide structure according to the fifth embodiment. FIG. 12 is a diagram showing a configuration of a cross-section (D3-D4) of the guide structure according to the fifth embodiment. FIG. 11 is a diagram schematically showing a cross-section taken along the cross-sectional line D1-D2 in FIG. 10. FIG. 12 is a diagram schematically showing a cross-section taken along the cross-sectional line D3-D4 in FIG. 10. The guide structure for restricting the rotation direction of the foot lever 100 includes the first area 100r of the foot lever 100 and guide members 185a and 185b. The guide member 185a is detachably supported by a plate-shaped member 198a. The guide member 185b is detachably supported by a plate-shaped member 198b.

The first area 100r of the foot lever 100 rotates while being sandwiched between the guide member 185a and the guide member 185b and positioned in the left-right direction, thereby restricting the rotation direction of the foot lever 100. As a result, the swing in the left-right direction can be reduced when the foot lever 100 rotates. In this case, since a rib 199a is connected to the plate-shaped member 198a and a rib 199b is connected to the plate-shaped member 198b, the lateral movements of the plate-shaped members 198a and 198b are restricted. Therefore, the swinging of the foot lever 100 (in particular, both end portions in the front-rear direction) in the left-right direction is further reduced. Hereinafter, each configuration of the guide structure will be described.

The plate-shaped members 198a and 198b are plate-shaped members protruding in the upper direction U from the bottom portion 190b and expanding in the front-rear direction. The plate-shaped member 198a and the plate-shaped member 198b are arranged to face each other. Part of the first area 100r of the foot lever 100 is arranged between the plate-shaped member 198a and the plate-shaped member 198b. The plate-shaped member 198a is arranged in the left direction L with respect to the foot lever 100. The plate-shaped member 198b is arranged in the right direction R with respect to the foot lever 100.

The rib portion 199a is a plate-shaped member that is connected to the plate-shaped member 198a and the bottom portion 190b and extends from the center portion of the plate-shaped member 198a in a direction (the left direction L) opposite to the foot lever 100. The rib portion 199b is a plate-shaped member that is connected to the plate-shaped member 198b and the bottom portion 190b and extends from the center portion of the plate-shaped member 198a in a direction (the right direction R) opposite to the foot lever 100.

The guide member 185a is detachably arranged on the plate-shaped member 198a so as to cover part of the side surface of the plate-shaped member 198a while avoiding the rib portion 199a. The guide member 185b is detachably arranged on the plate-shaped member 198b so as to cover part of the side surface of the plate-shaped member 198b while avoiding the rib portion 199b. The guide member 185a and the guide member 185b are connected to each other by a linking member 187. The linking member 187 is arranged at a position not in contact with the foot lever 100 in the range of rotation of the foot lever 100.

In this example, the guide members 185a, 185b and the linking member 187 are members having an integral structure by being integrally molded, and are formed of a material other than the foot lever 100 and the bottom portion 190b. For example, the guide member 185a, 185b and the linking member 187 are formed of a PBT resin. Other resins such as POM resin, ABS resin, nylon resin, PTFE resin, UHPE resin, PEEK resin, and the like may be used. The linking member 187 may not be present.

The guide member 185a includes an inner area 185a1, an outer area 185a2, and a side area 185a3. The inner area 185a1 is arranged on the side of the first area 100r with respect to the plate-shaped member 198a (the right direction R of the plate-shaped member 198a), and has a guide surface GFa that contacts the first area 100r of the foot lever 100. The outer area 185a2 is arranged on the opposite side to the first area 100r (the left direction L of the plate-shaped member 198a) with respect to the plate-shaped member 198a. The side area 185a3 connects the inner area 185a1 and the outer area 185a2. The inner area 185a1 and the outer area 185a2 sandwich the plate-shaped member 198a.

The plate-shaped member 198a is thinner in the upper direction U. The guide member 185a is attached to the plate-shaped member 198a by being pushed from above so as to insert the plate-shaped member 198a between the inner area 185a1 and the outer area 185a2. In this case, the portion between the inner area 185a1 and the outer area 185a2 is widened by the elastic deformation of the guide member 185a. As a result, the guide member 185a sandwiches the plate-shaped member 198a by the restoring force. In this state, the guide surface GFa forms a surface along the up-down direction (a surface along the rotation direction of the foot lever 100). Since the guide surface GFa and a guide surface GFb, which will be described later, are formed symmetrically, they are parallel to each other. The guide member 185a may have a configuration (a positioning portion or a locking portion) that is locked at a predetermined position with respect to the plate-shaped member 198a.

The lower stopper 181 is arranged in the bottom direction B of the inner area 185a1. The upper stopper 183 is arranged in the upper direction U of the inner area 185a1. In this example, the inner area 185a1 may be in contact with one or both of the lower stopper 181 and the upper stopper 183, and in this example, the inner area 185a1 is in contact with the lower stopper 181. As described above, the guide member 185a contacts the lower stopper 181 from the upper direction U by the inner area 185a1, whereby the lower stopper 181 fixed to the bottom portion 190b with an adhesive such as double-sided tape can be more firmly fixed, and peeling from the bottom portion 190b can be prevented even if the adhesive force decreases. Even if the inner area 185a1 does not touch the lower stopper 181, the range in which the lower stopper 181 moves can be limited. This also applies to the upper stopper 183.

The guide member 185b includes an inner area 185b1, an outer area 185b2, and a side area 185b3. Since the guide member 185b is symmetrical to the guide member 185a, detailed explanation thereof will be omitted. Since the foot lever 100 is sandwiched between the guide surface GFa formed in the inner area 185a1 and the guide surface GFb formed in the inner area 185b1, the rotational direction of the foot lever 100 is restricted. The guide surfaces GFa and GFb are not limited to being formed in the inner areas 185a1 and 185b1, and may be formed by opposing surfaces of the plate-shaped members 198a and 198b without using the guide members 185a and 185b.

### Sixth Embodiment

In a sixth embodiment, a pedal unit 10E in which the foot lever 100 is configured differently in a guide configuration of the fifth embodiment will be described.

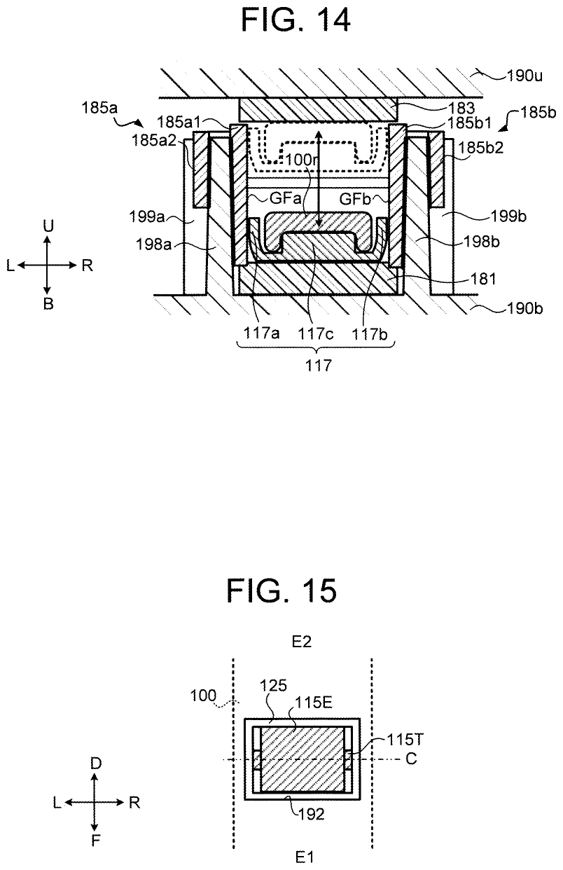

FIG. 13 is a diagram showing a configuration of a pedal unit according to the sixth embodiment. FIG. 14 is a diagram showing a configuration of a cross-section of a guide member according to the sixth embodiment. In FIG. 13, a configuration connected to a foot lever 100, which is a portion different from the fifth embodiment, is extracted and shown. The position of the cross-section in FIG. 14 is a position of the cross-section similar to that in FIG. 11. In this example, the guide surfaces GFa and GFb do not contact the first area 100r of the foot lever 100, but contact a contact member 117 attached to the foot lever 100. The contact member 117 has a contact area 117a, a contact area 117b, and a fixed area 117c.

The fixed area 117c is arranged between the contact area 117a and the contact area 117b and is fixed in the bottom direction B of the foot lever 100. The contact area 117a extends from the fixed area 117c in the left direction L beyond the first area 100r of the foot lever 100 and contacts the guide surface GFa while being elastically deformed. The contact area 117b extends from the fixed area 117c in the right direction R beyond the first area 100r of the foot lever 100 and contacts the guide surface GFb while being elastically deformed. That is, the contact member 117 is arranged in a state where a restoring force is applied from the foot lever 100 toward the guide surfaces GFa and GFb.

Therefore, the contact area 117a maintains the state of being in contact with the guide surface GFa by the restoring force. The contact area 117b maintains the state of being in contact with the guide surface GFb by the restoring force. Since the contact areas 117a and 117b are in contact with the guide surfaces GFa and GFb while applying the restoring force, they also function as the guide structure even if they are non-parallel in addition to the configuration in which the guide surface GFa and the guide surface GFb are parallel.

FIG. 15 is a diagram showing a configuration of a cross-section (E1-E2) of the shaft in the sixth embodiment. As shown in FIG. 13 and FIG. 15, a shaft 115E has a protruding portion 115T in the left-right direction thereof. Since the protruding portion 115T contacts the contact portion 125, the position of the foot lever 100 in the left-right direction is determined. In this example, the position of the foot lever 100 in the left-right direction is also determined in the first area 100r. Since the position of the foot lever 100 in the left-right direction in the vicinity of the center of rotation C of the foot lever 100 and in the first area 100r (the vicinity of the end portion) of the foot lever 100 is determined, the swing of the foot lever 100 in the left-right direction (in particular, both end portions in the front-rear direction) is further reduced as compared with the case where only one of the positioning is present.

This example further includes a connecting member 113 for connecting the shaft support portion 111 and the contact member 117. The shaft 115E, the shaft support portion 111, the connecting member 113, and the contact member 117 are integrally molded to have an integrated structure. Therefore, the accuracy of a positional relationship between the protruding portion 115T in the shaft 115E and the inner areas 185a1 and 185b1 in the contact member 117 is improved as compared with the case of having separate structures from each other. As in the first embodiment, the protruding portion 115T may not be present. The connecting member 113 may not be present, and the shaft 115E and the contact member 117 may not have an integral construction. In the case where the bearing 120A is present on the side of the foot lever 100 as in the second embodiment, the bearing 120A instead of the shaft 115E is connected to the contact member by the connecting member 113.

### [Modification]

The present disclosure is not limited to the embodiments described above and includes various other modifications. For example, the embodiments described above have been described in detail to explain the present disclosure clearly, and are not necessarily limited to those having all the described configurations. Other configurations may be added, deleted, or substituted for some of the configurations of the embodiments. Hereinafter, the first embodiment will be described as a modified example, but other embodiments can also be applied as a modified example. The embodiments described above and the modifications described below can be applied in combination with each other as long as there is no inconsistency.

(1) The shaft 115 and the bearing 120 may be connected to each other by snap fitting.
(2) The shaft 115 may protrude from the foot lever 100 in the left-right direction to make contact with the bearing 120 (contact portion 125) on the outside of the foot lever 100. This configuration may be realized by extending in the left-right direction from the shaft 115 and the bearing 120 present in the bottom direction B of the foot lever 100 (central area 100c) shown in an embodiment, or may be realized by only the portion protruding in the left-right direction.
(3) The contact sensor 173 may not be arranged. In this case, the protruding portion 161 of the reaction force adding member 165 may not be present. Furthermore, the reaction force adding member 165 may not be arranged.
(4) At least one of the lower stopper 181 and the upper stopper 183 may be arranged in the front direction F with respect to the center of rotation C. In this case, the upper stopper 183 is arranged in the lower direction B of the foot lever 100, and the lower stopper 181 is arranged in the upper direction U of the foot lever 100.
(5) Other sensors, such as a volumetric sensor, may be used as the stroke sensor 171 instead of an optical sensor. The stroke sensor 171 is not limited to being arranged in the upper space US, and may be arranged in the lower space LS or may be arranged in the left-right direction of the foot lever 100. The stroke sensor 171 is not limited to the example that detects the position of the first area 100r, and may detect the position of the second area 100f or may detect the amount of rotation of the shaft 115.
(6) One of the shaft 115 and the contact portion 125 may not have an arc at an edge portion in a cross-section perpendicular to the rotation axis. For example, the cross-section at the shaft 115 may be shaped to have two apex angle portions. If the distance from the center of rotation C to the respective apex angle portions is the same, the foot lever 100 can be rotated by sliding the two apex angle portions with the contact portion 125.
(7) Instead of arranging the contact portion 125 at the portion of the bearing 120 that contacts the shaft 115, it may be arranged at the portion that contacts the bearing as part of the shaft 115. In this case, the shaft 115 may include a contact portion arranged at least in a portion in contact with the bearing 120, and a shaft support portion that supports the contact portion from a side opposite to the contact surface. In this case, the contact portion and the shaft support portion are formed of different materials. Neither the bearing 120 nor the shaft 115 may have a configuration corresponding to the contact portion 125.
(8) The contact portion 125 may be arranged at part of a portion where the bearing 120 contacts the shaft 115.
(9) The contact portion 125 may have two or more areas of different materials from each other, and two or more areas may contact the shaft 115.
(10) At least two of the foot levers 100-1, 100-2, and 100-3 may have different shapes in at least one of the following points:
(a) Radius of the shaft 115 (distance from the center of rotation C to the contact surface)
(b) Magnitude of the force applied by the elastic member 155 on the first area 100r
(c) Magnitude of the reaction force by the reaction force adding member 165
(d) Presence or absence of the reaction force adding member 165

What is claimed is:

1. A pedal unit for an electronic musical instrument, the pedal unit comprising:
a case;
a foot lever including a first portion located inside the case and a second portion located outside the case, the foot lever being rotatably arranged with respect to the case, a center of rotation of the foot lever being located between the first portion and the second portion; and
an elastic member arranged inside the case and applying a force to the first portion.

2. The pedal unit according to claim 1, wherein the elastic member is disposed above the first portion.

3. The pedal unit according to claim 1, wherein the elastic member is a metal spring.

4. The pedal unit according to claim 1, further comprising a sensor disposed above the first portion and configured to detect a position of the foot lever as the foot lever rotates.

5. The pedal unit according to claim 1 wherein an upper surface of the second portion is horizontally disposed at a predetermined position in a rotatable range of the foot lever.

6. The pedal unit according to claim 1, wherein at least part of an upper surface of the first portion is disposed below an upper surface of the second portion at a predetermined position in a rotatable range of the foot lever.

7. The pedal unit according to claim 1, wherein an upper distal end portion of the second portion in the foot lever is disposed:
higher than the center of rotation at a rest position of the foot lever; and
lower than the center of rotation at a fully pressed position of the foot lever.

8. The pedal unit according to claim 1, wherein the center of rotation is disposed below an upper surface of the second portion at a rest position of the foot lever.

9. The pedal unit according to claim 1, wherein the case includes a support structure disposed underneath the foot lever and supporting at least one of a shaft or a bearing.

10. The pedal unit according to claim 1, wherein a width of part of the foot lever, which is arranged above the center of rotation, is wider than a width of an area where a shaft and a bearing face each other.

11. The pedal unit according to claim 1, wherein an edge in a cross-section of a shaft is arc shaped.

12. The pedal unit according to claim 1, wherein
the foot lever includes one of a shaft and a bearing, the shaft and the bearing forming the center of rotation, and
the case includes the other of the shaft and the bearing.

13. The pedal unit according to claim 1, wherein:
the center of rotation is located inside the case, and
at least part of an area where a shaft and a bearing face each other overlaps the second portion as the foot lever is viewed from above.

14. The pedal unit according to claim 1, further comprising:
a stopper supporting the first portion of the foot lever from below in a rest position of the foot lever,
wherein the elastic member applies a force above the first portion between the center of rotation and the stopper.

15. The pedal unit according to claim 1, further comprising:
a lower stopper and an upper stopper defining a range of rotation of the foot lever in the first portion; and
a guide member regulating a direction of rotation of the foot lever inside the case,
wherein part of the upper stopper is disposed above the guide member, and part of the lower stopper is disposed below the guide member.

16. The pedal unit according to claim 15, wherein the guide member is in contact with at least one of the upper stopper or the lower stopper.

17. The pedal unit according to claim 1, further comprising:
a guide member regulating a direction of rotation of the foot lever in the first portion; and
a contact member disposed on the first portion of the foot lever and moving in contact with the guide member as the foot lever rotates,
wherein the contact member is integral with any one of a shaft forming the center of rotation of the foot lever or a bearing facing the shaft.

18. The pedal unit according to claim 1, further comprising:
a guide member regulating a direction of rotation of the foot lever in the first portion; and
a contact member disposed on the first portion of the foot lever and moves in contact with the guide member as the foot lever rotates,
wherein the contact member includes an area for elastic deformation and is configured to apply a restoring force in a direction from the foot lever to the guide member.

19. The pedal unit according to claim 15, wherein:
the guide member includes a first guide surface and a second guide surface,
the first guide surface is disposed opposite to the second guide surface with respect to the foot lever, and
the first guide surface and the second guide surface are non-parallel.

20. The pedal unit according to claim 15, wherein:
the guide member includes a first guide surface and a second guide surface,
the first guide surface is disposed opposite to the second guide surface with respect to the foot lever, and
the first guide surface and the second guide surface are parallel to each other.

21. An electronic keyboard apparatus comprising:
a pedal unit comprising:
a case;
a foot lever including a first portion located inside the case and a second portion located outside the case, the foot lever being rotatably arranged with respect to the case, a center of rotation of the foot lever being located between the first portion and the second portion; and
an elastic member arranged inside the case and applying a force to the first portion;
a keyboard unit having a plurality of keys; and
a sound source unit configured to generate a sound signal according to an operation to the plurality of keys and an operation to the foot lever on the pedal unit.
